(19) United States
(12) Patent Application Publication
(10) Pub. No.: US 2003/0110219 A1
(43) Pub. Date: Jun. 12, 2003

(54) Collaboration system and data structure thereof

(76) Inventors: Chih-Hao Hsu, Taipei Hsien (TW); Mei-Chun Chen, Taipei Hsien (TW)

Correspondence Address: MERCHANT & GOULD PC, P.O. BOX 2903, MINNEAPOLIS, MN, 55402-0903, US

(21) Appl. No.: 10/068,222

(22) Filed: Feb. 6, 2002

(30) Foreign Application Priority Data
Dec. 11, 2001 (TW) 90130692

(51) Int. Cl. G06F 15/16; G06F 17/00

(52) U.S. Cl. 709/204; 707/104.1

(57) ABSTRACT

A method of storing data for a collaboration system. In the collaboration system, a first and second data are respectively used for implementation of a plurality of child processes and a parent process comprising the child processes. The method comprises the steps of storing the first and second data, storing a link in the first data, and linking the first and second data by the link.

### BACKGROUND OF THE INVENTION

1. Field of the Invention

The present invention relates to a collaboration system, particularly to a data structure of the collaboration system which enhances the efficiency of data access.

2. Description of the Prior Art

A collaboration system supports collaboration of enterprises in a supply chain by providing a layered framework which allows integration of business processes and sharing of information.

FIG. 1 is a diagram showing a collaboration system. The system comprises three members 12, 13 and 14,(enterprise A, B and C), a collaboration center 11, and a storage device 15 for storing a database of the system.

The operation of the system will be explained in conjunction with FIG. 1 and FIG. 2. For example, when enterprise A gives an order to enterprise B to purchase products manufactured by the enterprise B, the collaboration center 11 manages the whole process. The collaboration center 11 accesses the database stored in the storage device 15 to obtain data 21 of a parent process for ordering. The data 21 comprises an identification 211 of child processes, an identification 212 of participants in the parent process and a message 213. The parent process for ordering comprises four ordered child processes (Order Establishment, Order Receiving, Delivery and Goods Receiving) which are identified by the identification 211. The identification 212 identifies a participant Coordinator in the parent process for ordering. The message 213 comprises formats and contents of the buyer's order, seller's response, delivery notice and goods received notice.

Then, the child processes are implemented. The first child process Order Establishment is implemented by enterprise A. The member 12 accesses the database stored in the storage device 15 to obtain data 22 of the child process Ordering Establishing. The data 22 comprises an identification 221 of grandchild processes, an identification 222 of participants in the child process Order Establishment and a message 223. The child process Order Establishment comprises two ordered grandchild Processes (Order Adding and Order Checking) which are identified by the identification 221. The identification 222 identifies a participant Logistic Department in the child process Order Establishment. The message 223 comprises formats and contents of the buyer's order and checking results.

Similarly, the grandchild processes Order Adding and Order Checking are implemented in the same way.

After the child process Order Establishment is finished, the member 12 or 13 continues to implement the other child processes in the order defined by the identification 211.

Further, each member 12, 13 or 14 is allowed to register new or modified data of their own child processes in the database stored in the storage device 15. Thus, a flexibility in the child processes implemented by the members 12, 13 and 14 is maintained under the same framework.

Conventionally, all the data of the processes stored in the database are related through a relational table shown in FIG. 3, including Data A of a parent process, data B and C of child processes, and data D, E, and F of grandchild processes. The relational table 31 has columns Parent and Child, and shows the relationship of the data A, B, C, D, E and F.

However, the conventional data structure of the database results in low efficiency of data access since the relational table 31 must be searched from top to bottom until the data to be accessed is located.

### SUMMARY OF THE INVENTION

Therefore, the object of the present invention is to provide a data structure of a collaboration system having high efficiency of data access.

The present invention provides a method of storing data for a collaboration system. In the collaboration system, first and second data are respectively used for implementation of a plurality of child processes and a parent process comprising the child processes. The method comprises the steps of storing the first and second data, storing a link in the first data, and linking the first and second data by the link.

The present invention further provides a collaboration system. The system comprises a collaboration center obtaining first data for implementation of a parent process comprising a plurality of child processes, a member obtaining second data for implementation of the child processes, and a storage device storing the first and second data, and storing a link in the second data to link the first and second data.

Consequently, the data of the parent and child processes are linked together instead of being related by a relational table. This avoids repeatedly searching the entire relational table every time the database is accessed so that high efficiency of data access is obtained.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a diagram showing a collaboration system.

FIG. 2 is a diagram showing the layered process implementation framework of the collaboration system.

FIG. 3 is a diagram showing a conventional data structure in the database of the collaboration system.

FIG. 4 is a diagram showing a data structure in the database of the collaboration system according to one embodiment of the invention.

FIG. 5 is a flow chart of a method of storing data for a collaboration system according to one embodiment of the invention.

### DETAILED DESCRIPTION OF THE INVENTION

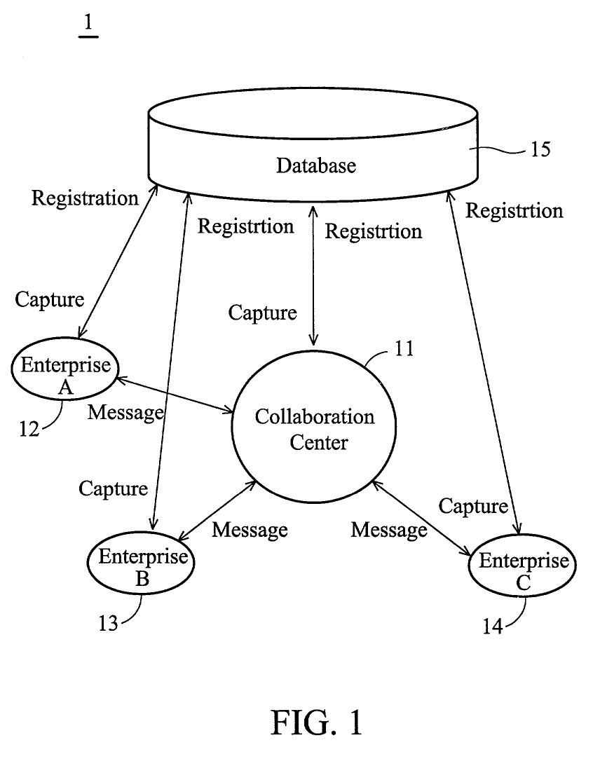

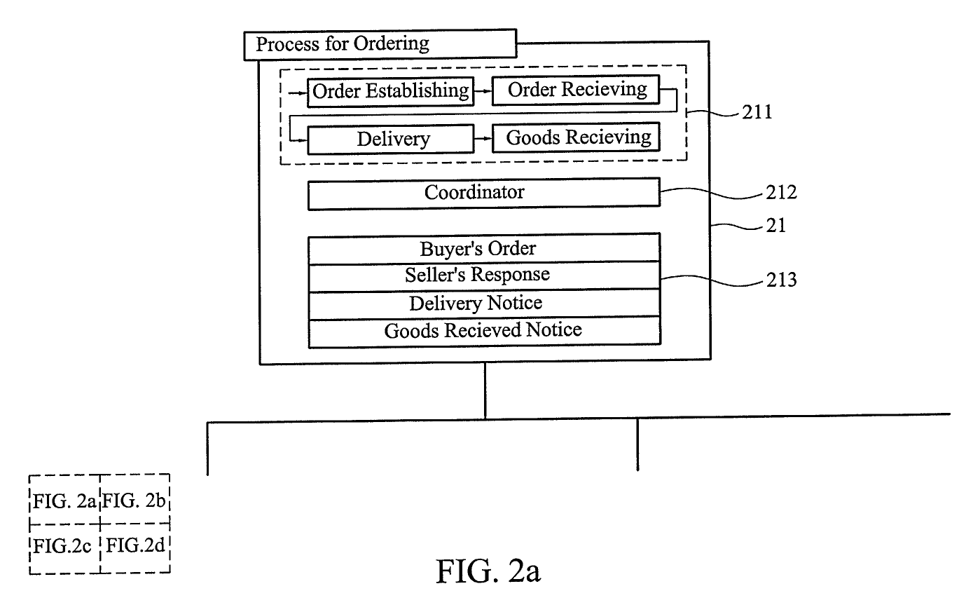

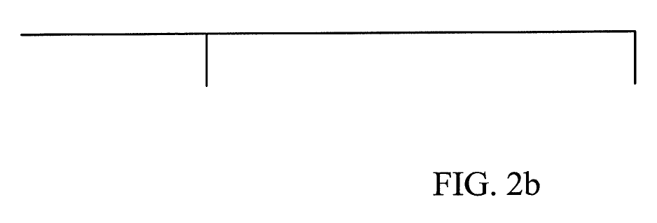

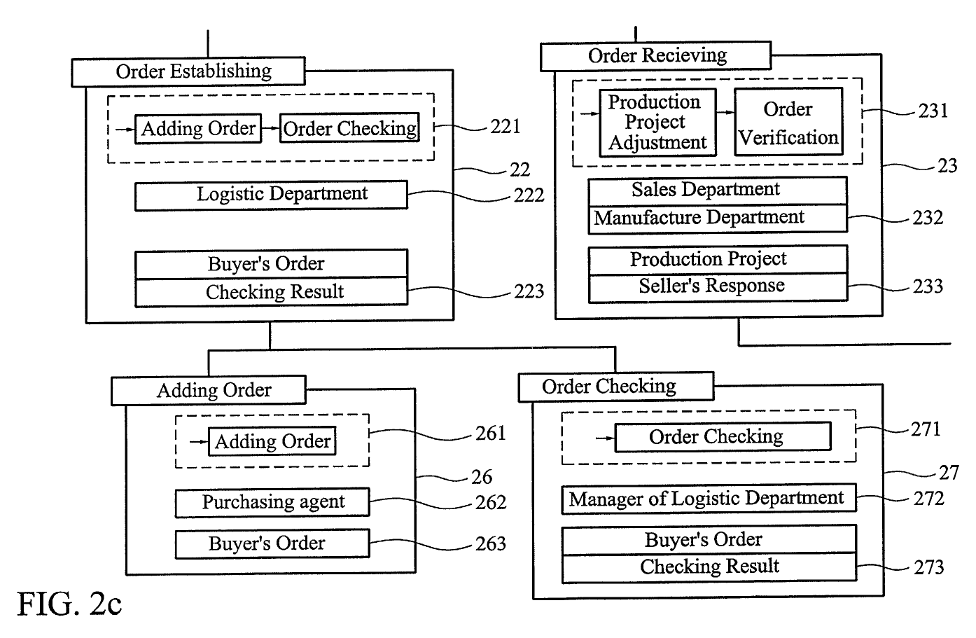

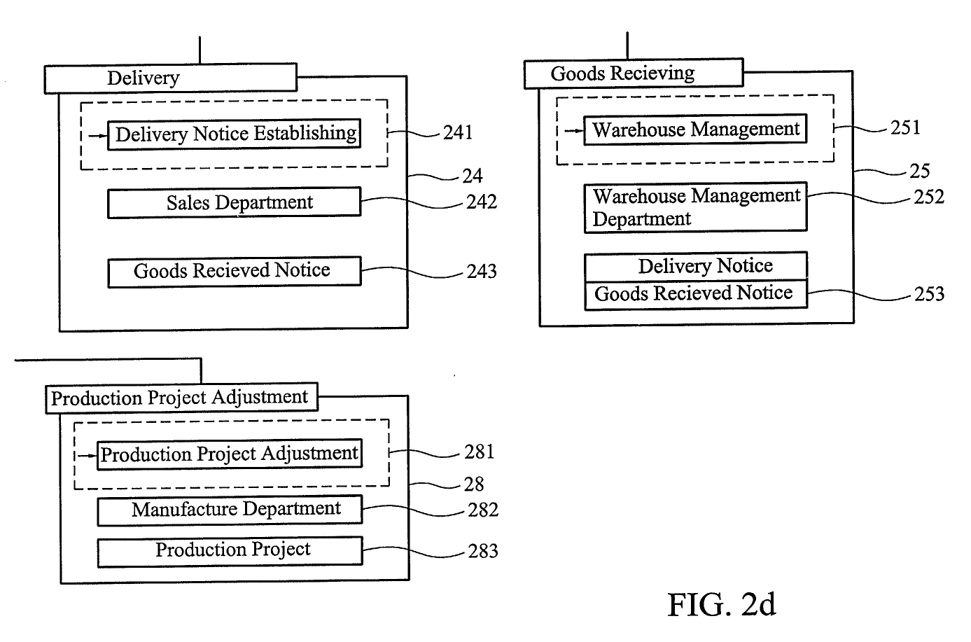

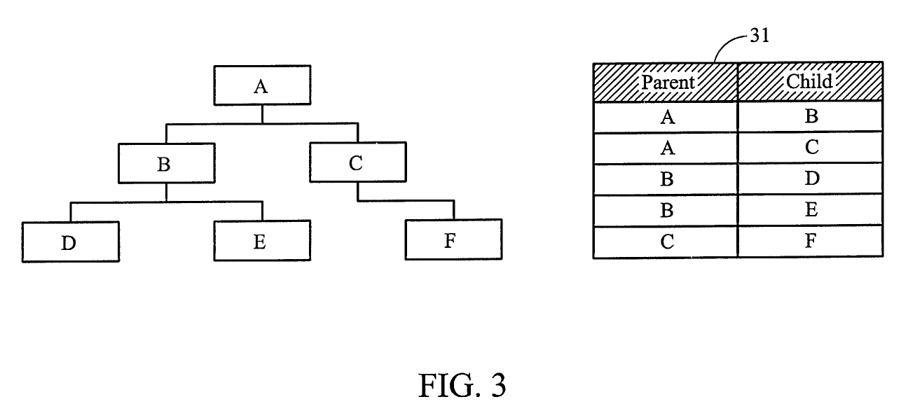

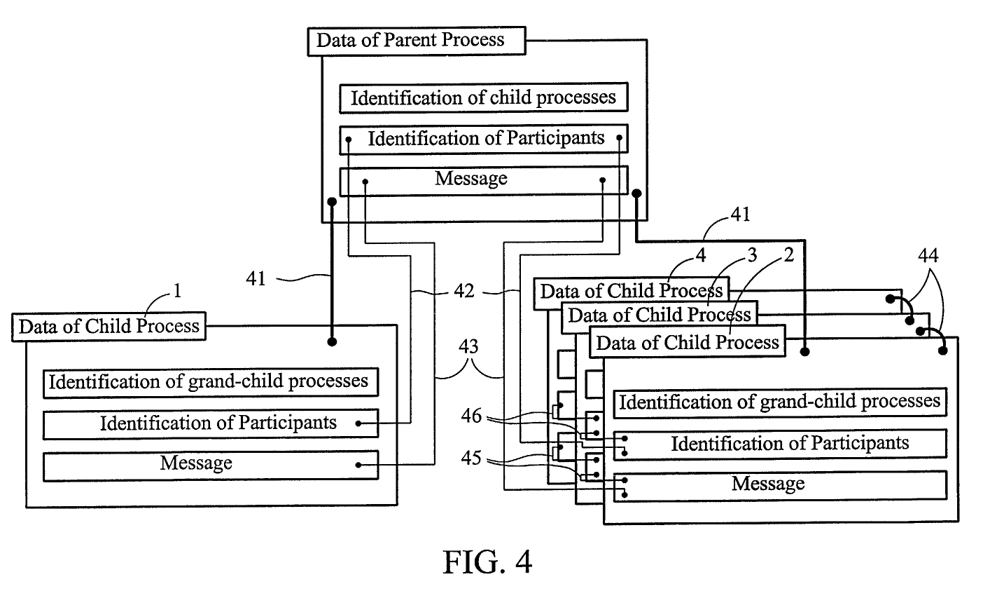

FIG. 4 is a diagram showing a data structure in the database of a collaboration system according to one embodiment of the invention. The collaboration system in this embodiment is the same as that shown in FIG. 1 except for the data structure of the database, and has the same process implementation framework as that shown in FIG. 2.

The data structure of the data base stored in the storage device 15 will be explained in conjunction with FIG. 4. FIG. 4 shows a data structure comprising data of a parent process and four child processes 1˜4 for example. The parent process is composed of the four child processes 1˜4. The child processes 2˜4 implement the same activity as the parent process. More specifically, the child processes 2˜4 implement the activity Order Establishment, for example, but have different grandchild processes, participants, formats, and content of messages since they are defined by different enterprises. In addition to the identification of the child (or grandchild) processes and participants, and the message, there are a process link 41, participant link 42 and message link 43 stored in the data of the child processes 1˜4. The data of the child processes 1˜4, the identification of the participants and the messages therein are linked to those of the parent process by the process link 41, participant link 42 and message link 43 respectively. Further, there are a process link 44, participant link 46 and message link 45 stored in the data of the child processes 2˜4. The data of the child process 2, the identification of the participants and the message therein are linked to those of the child process 3 by the process link 44, participant link 46 and message link 45 respectively. The data of the child process 3, the identification of the participants and the message therein are linked to those of the child process 4 by the process link 44, participant link 46 and message link 45 respectively. The child processes 2˜4 for implementation of the same activity in the parent process are linked together in a parallel arrangement.

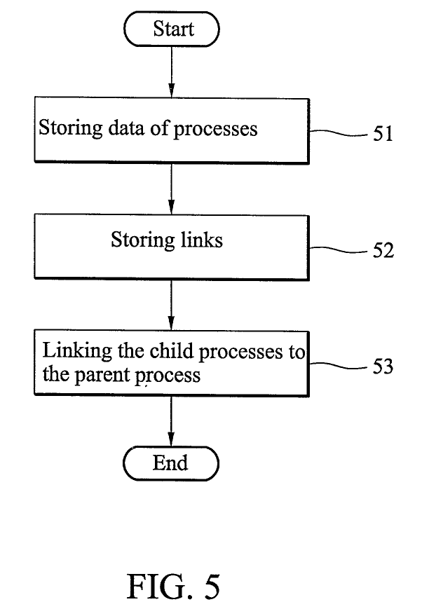

FIG. 5 is a flow chart of a method of storing data for a collaboration system according to one embodiment of the invention.

In step 51, data of child processes and a parent process comprising the child processes are stored. The data of the processes comprises an identification of child or grandchild processes, an identification of participants in the process and a message generated in the process.

In step 52, a process link, participant link and message link are stored in the data of the child processes.

In step 53, The data of the child processes, the identification of the participants and the messages therein are linked to those of the parent process by the process link, participant link and message link respectively.

In conclusion, the present invention provides a new data structure of a collaboration system. The data of the parent and child processes are linked together instead of being related by a relational table. This avoids repeated searches of the relational table every time the database is accessed, and thus high efficiency of data access is obtained.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of storing data for a collaboration system wherein first and second data are respectively used for implementation of a plurality of child processes and a parent process comprising the child processes, the method comprising the steps of:
storing the first and second data;
storing a link in the first data; and
linking the first and second data by the link.

2. The method as claimed in claim 1 wherein the second data comprises identification of the child processes.

3. The method as claimed in claim 1 wherein the first and second data comprise identification of participants in the child and parent processes.

4. The method as claimed in claim 3 further comprising the steps of:
storing a second link in the first data; and
linking the identification of the participants in the child and parent processes by the second link.

5. The method as claimed in claim 1 wherein the first and second data comprise messages generated in the child and parent processes.

6. The method as claimed in claim 5 further comprising the steps of:
storing a third link in the first data; and
linking the messages generated in the child and parent processes by the third link.

7. A collaboration system comprising:
a collaboration center obtaining first data for implementation of a parent process comprising a plurality of child processes;
a member obtaining second data for implementation of the child processes; and
a storage device storing the first and second data, and storing a link in the second data to link the first and second data.

8. The collaboration system as claimed in claim 7 wherein the first data comprises identification of the child processes.

9. The collaboration system as claimed in claim 7 wherein the first and second data comprise identification of participants in the parent and child processes.

10. The collaboration system as claimed in claim 9 wherein the storage device further stores a second link in the second data to link the identification of the participants in the parent and child processes.

11. The collaboration system as claimed in claim 7 wherein the first and second data comprise messages generated in the parent and child processes.

12. The collaboration system as claimed in claim 11 wherein the storage device further stores a third link in the second data to link the messages generated in the parent and child processes.
